(19) United States
(12) Patent Application Publication
(10) Pub. No.: US 2026/0129415 A1
(43) Pub. Date: May 7, 2026

(54) WIRELESS COMMUNICATION METHOD AND APPARATUS OF SUPPORTING ARTIFICIAL INTELLIGENCE

(71) Applicant: LENOVO (BEIJING) LIMITED, Beijing (CN)

(72) Inventors: Congchi ZHANG, Shanghai (CN); Jianfeng WANG, Beijing (CN); Mingzeng DAI, Shanghai (CN); Le YAN, Shanghai (CN); Haiming WANG, Beijing (CN)

(21) Appl. No.: 18/703,882

(22) PCT Filed: Nov. 1, 2021
(86) PCT No.: PCT/CN2021/127964

§ 371 Date: Apr. 23, 2024

(51) Int. Cl. H04W 4/50

(52) U.S. Cl. CPC H04W 4/50

(57) ABSTRACT

Embodiments of the present application relate to a wireless communication method and apparatus of supporting artificial intelligence. An exemplary method may include: receiving, first configuration information on a protocol layer responsible for artificial intelligence (AI) management in access stratum, from a network side; receiving, indication information on a set of AI operations from the network side; and transmitting, feedback on at least one of the set of AI operations to the network side, via a message on the protocol layer based on the first configuration information.

### TECHNICAL FIELD

Embodiments of the present application are related to wireless communication technology, especially, related to artificial intelligence (AI) application in wireless communication, e.g., a wireless communication method and apparatus of supporting AI.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” to learn how to solve problems and/or optimize performance from vast amounts of data.

If AI models used on AI-based methods are well trained, the AI-based methods can obtain better performance than traditional methods. Thus, 3rd generation partnership program (3GPP) has been considering to introduce AI into 3GPP since 2016, including several study items and work items in SA1, SA2, SA5 and RAN3. In the current 3GPP radio access network (RAN) release (R) 18 candidate proposal discussions, an AI model can be used to optimize user equipment (UE) and RAN operation in access stratum (AS), which includes: UE can use an AI model to better estimate the channel condition at physical (PHY) layer; and RAN nodes can use an AI model to predict UE mobility and make proper handover decisions.

Thus, interactions between UE and RAN nodes are needed to exchange AI models and/or relevant parameters in some cases, for example: AI models used by UE are provided by the RAN node to do channel condition estimation; and the AI model used by the RAN node to predict UE mobility (i.e., a mobility prediction model) can be trained in a distributed learning way. An exemplary distributed learning way is: a number of UEs can assist the RAN node to train the mobility prediction model using their local data and send the updated model parameters back to the RAN node.

Comparing with the conventional AI model distributions (or operations) at the application layer, e.g., AI model distributions or operations for autonomous driving, AI models for AS operations as illustrated above may only be applicable in the access stratum and does not need to be aware by the application layer. However, neither the user plane (UP) nor control plane (CP) in current access stratum is appropriate to support interactions associated with AI task and AI model between UE and the RAN node.

Therefore, how to handle the AI model distributions (or operations) and AI task participation (e.g., distributed learning) in access stratum should be solved.

### SUMMARY

One objective of the embodiments of the present application is to provide a technical solution for wireless communication, especially for supporting AI in wireless communication, which can solve the technical problem on how to handle AI model distribution and AI task participation in AS.

Some embodiments of the present application provide a UE, which includes: at least one receiving circuitry; at least one transmitting circuitry; and at least one processor coupled to the at least one receiving circuitry and the at least one transmitting circuitry, wherein the at least one processor is configured to: receive, via the at least one receiving circuitry, first configuration information on a protocol layer responsible for AI management in access stratum from a network side; receive, via the at least one receiving circuitry, indication information on a set of AI operations from the network side; and transmit, via the at least one transmitting circuitry, feedback on at least one of the set of AI operations to the network side, via a message on the protocol layer based on the first configuration information.

In some embodiments of the present application, each AI operation of the set of AI operations is related to at least one of: AI task or AI model.

In some embodiments of the present application, the first configuration information is transmitted via a radio resource control (RRC) message.

In some embodiments of the present application, the first configuration information indicates at least one of the following: a list of descriptions about AI operations that a base station can provide or want UE to support; a list of indexes about AI operations that a base station can provide or want UE to support; an index identifying a current entity of the protocol layer; associated radio bearer ID(s) to identify an associated protocol data convergence protocol (PDCP) entity; an indication to update an AI operations list in a base station; or rules to provide AI model performance feedback to a base station.

In some embodiments of the present application, the at least one processor is further configured to: receive, via the at least one receiving circuitry, second configuration information on a PDCP entity associated with an entity of the protocol layer, wherein the second information indicates at least one of the following: an indicator implying the PDCP entity; or an index identifying the entity of the protocol layer.

In some embodiments of the present application, the at least one processor is further configured to: receive, via the at least one receiving circuitry, third configuration information on a radio link control (RLC) entity associated with an entity of the protocol layer, wherein the RLC entity is always configured in a RLC acknowledged mode or is in a default RLC acknowledged mode.

In some embodiments of the present application, for the set of AI operations, at least one entity of the protocol layer is configured as follows: in the case that there is at least one AI task in the set of AI operations, a corresponding entity of the protocol layer is configured for each AI task; and in the case that there is at least one AI model in the set of AI operations, a corresponding entity of the protocol layer is configured for each AI model; or only one entity of the protocol layer is configured for the set of AI operations.

In some embodiments of the present application, the at least one of the set of AI operations is assigned to the UE based on a decision of a base station.

In some embodiments of the present application, the indication information indicates a requirement on the set of AI operations in a RRC message or a message of the protocol layer, and the at least one of the set of AI operations is adopted by the UE based on implementation of the UE.

In some embodiments of the present application, the at least one processor is further configured to: receive, via the at least one receiving circuitry, a first message including indication information on the set of AI operations; transmit, via the at least one transmitting circuitry, a second message indicating to subscribe at least part of the set of AI operations; and receive, via the at least one receiving circuitry, a third message indicating the at least one of the set of AI operations. In the case that the protocol layer is configured for the UE before receiving the first message, the first message is one of a RRC message, system information block (SIB) and a message of the protocol layer; the second message is one of a RRC message and a message of the protocol layer; and the third message is a message of the protocol layer. In the case that the protocol layer is configured for the UE after receiving the first message and before transmitting the second message, the first message is one of a RRC message and SIB; the second message is one of a RRC message and a message of the protocol layer; and the third message is a message of the protocol layer. In the case that the protocol layer is configured for the UE after transmitting the second message and before receiving the third message, the first message is one of a RRC message and SIB; the second message is a RRC message; and the third message is a message of the protocol layer. In the case that the protocol layer is configured for the UE after receiving the third message, the first message is one of a RRC message and SIB; and the second message and third message are RRC messages.

In some embodiments of the present application, a message format of the protocol layer includes: control protocol data unit (PDU) and data PDU, wherein the control PDU and data PDU are sent over different logical channels (LCHs) and radio bearers.

In some embodiments of the present application, a control PDU of the protocol layer includes information indicating at least one of the following: message type; subscribe or unsubscribe; index of AI task wanted to subscribe or unsubscribe; index of AI model wanted to subscribe or unsubscribe; and list of index of available AI operations from a base station.

In some embodiments of the present application, a data PDU of the protocol layer includes information indicating at least one of the following: message type; AI task index; AI model index; input AI task index; input AI model index; output AI task index; output AI model Index; and model payload.

Some embodiments of the present application provide a network apparatus, which includes: at least one receiving circuitry; at least one transmitting circuitry; and at least one processor coupled to the at least one receiving circuitry and the at least one transmitting circuitry, wherein the at least one processor is configured to: transmit, via the at least one transmitting circuitry, first configuration information on a protocol layer responsible for AI management in access stratum, from a network side to a UE; transmit, via the at least one transmitting circuitry, indication information on a set of AI operations from the network side; and receive, via the at least one receiving circuitry, feedback on at least one of the set of AI operations from the UE, via a message on the protocol layer based on the first configuration information.

In some embodiments of the present application, the at least one processor is further configured to: transmit, via the at least one transmitting circuitry, second configuration information on a PDCP entity associated with an entity of the protocol layer, wherein the second information indicates at least one of the following: an indicator implying the PDCP entity; or an index identifying the entity of the protocol layer.

In some embodiments of the present application, the at least one processor is further configured to: transmit, via the at least one transmitting circuitry, third configuration information on a RLC entity associated with an entity of the protocol layer, wherein the RLC entity is always configured in a RLC acknowledged mode or is in a default RLC acknowledged mode.

In some embodiments of the present application, the at least one processor is configured to: transmit, via the at least one transmitting circuitry, a first message including indication information on the set of AI operations; receive, via the at least one receiving circuitry, a second message indicating to subscribe at least part of the set of AI operations; and transmit, via the at least one transmitting circuitry, a third message indicating the at least one of the set of AI operations. In the case that the protocol layer is configured for the UE before transmitting the first message, the first message is one of a RRC message, SIB and a message of the protocol layer; the second message is one of a RRC message and a message of the protocol layer; and third message is a message of the protocol layer. In the case that the protocol layer is configured for the UE after transmitting the first message and before receiving the second message, the first message is one of a RRC message and SIB; the second message is one of a RRC message and a message of the protocol layer; and third message is a message of the protocol layer. In the case that the protocol layer is configured for the UE after receiving the second message and before transmitting the third message, the first message is one of a RRC message and SIB; the second message is a RRC message; and the third message is a message of the protocol layer. In the case that the protocol layer is configured for the UE after transmitting the third message, the first message is one of a RRC message and SIB; and the second message and the third message are RRC messages.

Some embodiments of the present application also provide a wireless communication method, which includes: receiving, first configuration information on a protocol layer responsible for AI management in access stratum, from a network side; receiving, indication information on a set of AI operations from the network side; and transmitting, feedback on at least one of the set of AI operations to the network side, via a message on the protocol layer based on the first configuration information.

Given the above, embodiments of the present application propose a technical solution of supporting AI in wireless communication, especially a dedicated protocol layer in access stratum for AI model distributions and AI task participation, which will facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2A illustrates a 5G air interface protocol stack over the UP in access stratum between UE and gNB.

FIG. 2B illustrates a 5G air interface protocol stack over the CP in access stratum between UE and gNB.

FIG. 3 illustrates a protocol stack over the computing plane in access stratum between UE and gNB according to some embodiments of the present application.

FIG. 4 is a flow chart illustrating an exemplary procedure of a wireless communication method of supporting AI according to some other embodiments of the present application.

FIG. 5 is a flow chart illustrating an exemplary subscription procedure according to some embodiments of the present application.

FIG. 6 illustrates an exemplary control PDU of AMMP layer according to some embodiments of the present application.

FIG. 7 illustrates an exemplary data PDU of AMMP layer according to some embodiments of the present application.

FIG. 8 illustrates a block diagram of a wireless communication apparatus of supporting AI according to some embodiments of the present application.

FIG. 9 illustrates a block diagram of a wireless communication apparatus of supporting AI according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long-term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

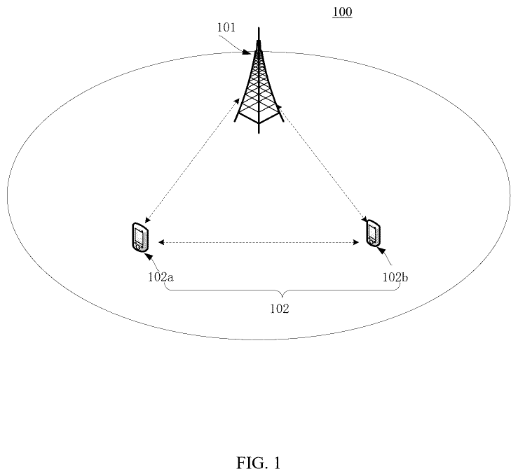

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

3GPP has been considering introducing AI capability (or application) for communication since 2016. According to the current 3GPP RAN R18 candidate proposal discussions, an AI model can be used to optimize UE and RAN operation in AS, wherein the interaction between UE and RAN node is needed to exchange AI models or relevant parameters etc. in AS. However, so far, all frameworks or architectures proposed for AI-based RAN are just high-level descriptions without detailed design, especially considering the dedicated protocol layer design, configuration and operation etc. to manage AI tasks and AI models.

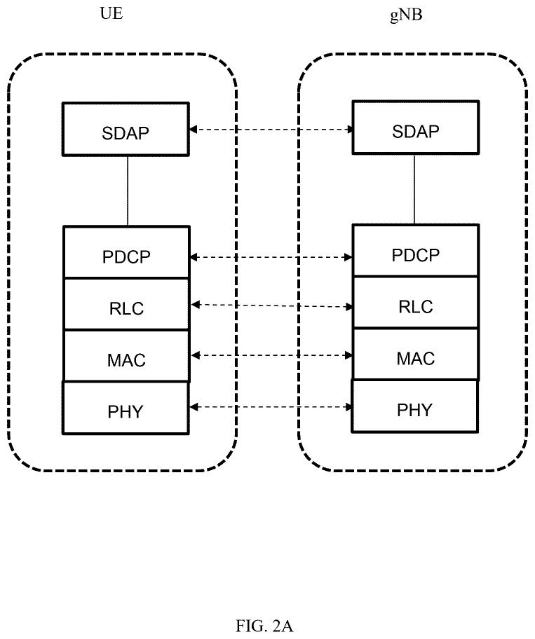

FIG. 2A illustrates a 5G air interface protocol stack over the UP in access stratum between UE and gNB. FIG. 2B illustrates a 5G air interface protocol stack over the CP in access stratum between UE and gNB.

Referring to FIGS. 2A and 2B, there are service data adaptation protocol (SDAP) layer, PDCP layer, RLC layer, medium access control (MAC) layer and PHY layer over the UP in access stratum. The UP in access stratum is designed to deliver application layer packets via SDAP layer. There are RRC layer, PDCP layer, RLC layer, MAC layer and PHY layer over UP in access stratum. The CP in access stratum is designed to deliver configuration information via RRC layer for UE behavior and each protocol layer entity in the CP for transmission and reception. Since the interactions between UE and gNB for exchanging AI tasks and/or AI models in access stratum are not needed to be available at the application layer, the UP in access stratum is not suitable for such interactions in access stratum. Herein (throughout the specification), the wording “A and/or B” means “both A and B, or one of A and B,” or “at least one of: A and B,” or the like. For example, AI tasks and/or AI models means: AI tasks and AL models, or AI tasks, or AI models. Meanwhile, since the requirement on configuring AI task and/or AI model related distribution is different from legacy AI task and/or AI model distribution, e.g., AI task and/or AI model distribution for autonomous driving at the application layer, the CP in access stratum is also not suitable for such interactions in access stratum. Thus, how to support the interactions between UE and gNB for exchanging AI tasks and/or AI models in access stratum should be solved.

At least to solve the above technical problem, embodiments of the present application propose a technical solution associated with AI application in a wireless communication system (or network), especially propose a dedicated protocol layer to manage AI operations in AS, including AI enhancement for the air interface and NG-RAN evolution in 5.5G and 6G. Herein, the wording “AI” at least includes ML, which may also be referred to as AI/ML etc., and the wording “AI operation” means AI task, or AI model, or AI task and AI model.

According to embodiments of the present application, a protocol layer responsible for AI management in access stratum is provided, which is referred to as an AI model management protocol (AMMP) layer for simplification and clearness. Accordingly, a message on the protocol layer responsible for AI management in access stratum can be referred to as an AMMP message, and an entity of the protocol layer responsible for AI management in access stratum can be referred to as an AMMP entity. AMMP layer can be used for but not limited to the following: AI task and AI model management; AI task and AI model assignment, subscription and unsubcription; AI task and AI model deployment, update and application to a corresponding protocol layer, e.g., PHY layer; and AI task and AI model feedback, e.g., AI model performance feedback.

Based on AMMP layer, a new plane including AMMP layer is also introduced in access stratum, which is referred to as a computing plane. As the same as “AMMP layer,” “AMMP message” and “AMMP entity,” persons skilled in the art should well know that the terminology “computing plane” is also used to illustrate embodiments of the present application for simplification and clearness, and they may evolve other terminologies in the future.

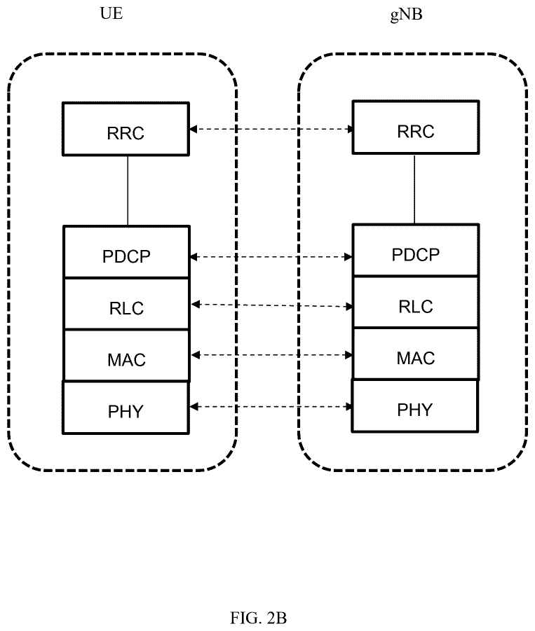

FIG. 3 illustrates a protocol stack over the computing plane in access stratum between UE and gNB according to some embodiments of the present application.

The computing plane is parallel to CP and UP in access stratum. Referring to FIG. 3, AMMP layer is parallel to RRC layer in CP and SDAP layer in UP. Besides AMMP layer, there are also PDCP layer, RLC layer, MAC layer and PHY layer over the computing plane in access stratum. All the received packets delivered to AMMP layer will not be further delivered to the application layer. In other word, AMMP layer is considered as a part of access stratum and all the transmitted and received AMMP layer packets remain in access stratum.

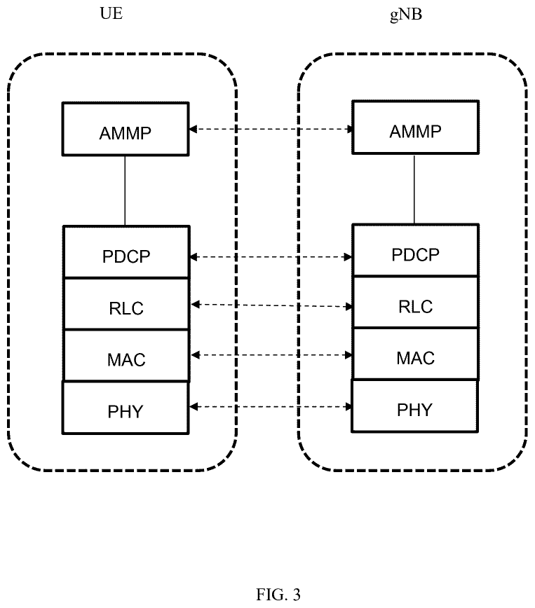

Based on AMMP layer, interactions between UE and RAN nodes, e.g., for optimizing UE and RAN operation in access stratum by AI can be supported. FIG. 4 is a flow chart illustrating an exemplary procedure of a wireless communication method of supporting AI according to some embodiments of the present application. Although the method is illustrated in a system level by an network apparatus in the network side, e.g., a gNB and a remote apparatus in the remote side, e.g., a UE, persons skilled in the art can understand that the method implemented in the network side and that implemented in the remote side can be separately implemented and incorporated by other apparatus with the like functions.

As shown in FIG. 4, the network side, e.g., a gNB transmits first configuration information on AMMP layer to the remote side, e.g., a UE in step 401. Correspondingly, the remote side, e.g., the UE receives the first configuration on AMMP layer in step 402. Persons skilled in the art should well know that the wording “a/the first,” “a/the second” and “a/the third” etc. are only used for clear description, and should not be deemed as any substantial limitation, e.g., sequence limitation.

The first configuration information is the configuration information used for configuring AMMP layer for UE by the network side, and can be transmitted to the UE via a high layer signaling (or message) over the CP in access stratum, e.g., a RRC message over the CP in access stratum. For example, when the network side knows that the UE is AI capable, or knows that the UE is willing to subscribe at least one AI operation, the network side may transmit the first configuration information to the UE via a RRC message to the UE, so that AMMP layer will be configured for the UE.

According to some embodiments of the present application, the first configuration information indicates at least one of the following: a list of descriptions about AI operations that a base station can provide or want UE to support; a list of indexes about AI operations that a base station can provide or want UE to support; an index identifying a current AMMP entity; associated radio bearer ID(s) to identify an associated PDCP entity; an indication to update an AI operations list in a base station; or rules to provide AI model performance feedback to a base station. For example, the first configuration information may indicate a list of descriptions about AI operations that a gNB can provide or want UE to support and an index identifying a current AMMP entity. In another example, the first configuration information may indicate a list of indexes about AI operations that a gNB can provide or want UE to support; an index identifying a current AMMP entity; associated radio bearer ID(s) to identify an associated PDCP entity; and rules to provide AI model performance feedback to a gNB.

An exemplary RRC message for transmitting the first configuration information may contain an AMMP-Config element, which further contains a list of AvailableAiModel and a list of AvailableAiTask. Exemplary elements and the content of each element of such AMMP layer configuration information in the RRC message are illustrated as following:

| | |
|---|---|
| AMMP- Config ::= | SEQUENCE { |

AMMP-ID

| | |
|---|---|
| AvailableAiModelList | SEQUENCE { |
| AvailableAiModel | ENUMERATED {channelestimation, |

```
  mobilityestimation}
    }
```

| | |
|---|---|
| AvailableAiTaskList | SEQUENCE { |
| AvailableAiTask | ENUMERATED |

```
  {channelestimationfederatedlearning,
  mobilityestimationfederatedlearning}
  }
```

In some embodiments of the present application, the AMMP entity and its associated PDCP entity and RLC entity in access stratum are also configured by a RRC signaling over the CP in access stratum.

Regarding the AMMP entity, each AMMP entity is associated with one or more radio bearers and one or more logical channels for packets transmission and reception.

According to some embodiments of the present application, a configuration manner for the AMMP entity is that: an AMMP entity can be configured per AI task and per AI model. For example, for a set of AI operations, at least one AMMP entity is configured as follows: in the case that there is at least one AI task in the set of AI operations, a corresponding AMMP entity is configured for each AI task; and in the case that there is at least one AI model in the set of AI operations, a corresponding AMMP entity is configured for each AI model. Herein, the wording “a set of” means one or more, or at least one, or the like. Each AI operation of the set of AI operations is related to at least one of: AI task or AI model. For example, the set of AI operations may be one or more AI tasks. In another example, the set of AI operations may be one or more AI models. In yet another example, the set of AI operations may be at least one AI task and at least one AI model.

According to some other embodiments of the present application, another configuration manner for the AMMP entity is that: only one AMMP entity is configured for all AI task(s) and AI model(s). For example, for a set of AI operations, only one AMMP entity is configured for the set of AI operations regardless how many AI tasks and/or AI models there are in the set of AI operations.

Regarding the PDCP entity associated with the AMMP entity in access stratum, the network side may configure it for UE by transmitting second configuration information on the PDCP entity associated with the AMMP entity to the UE. The second information indicates at least one of the following: an indicator implying the PDCP entity, or an index identifying the entity of the protocol layer. For example, the second information may indicate an indicator implying the PDCP entity, or indicate an index identifying the AMMP entity, or indicates both the indicator implying the PDCP entity and the index identifying the AMMP entity.

Regarding the RLC entity associated with the AMMP entity in access stratum, the network side may configure it by transmitting third configuration information on the RLC entity associated with the AMMP entity. In some embodiments of the present application, considering that any packet loss related to AI operation, e.g., packet loss related to AI model is not tolerable, the RLC entity is always configured in a RLC acknowledged mode or is in a default RLC acknowledged mode.

AI operations in the network side can be assigned to the UE by the network side or can be subscribed by the UE, so that gNB and UE can cooperate to achieve an AI task jointly or maintain AI model life cycle management etc. For example, in step 403, the network side, e.g., the gNB transmits indication information on a set of AI operations to the remote side, e.g., UE. Correspondingly, the remote side, e.g., the UE will receive the indication information on the set of AI operations in step 404.

According to some embodiments of the present application, when the network side, e.g., a gNB is aware that UE is AI capable and AMMP layer has been configured to UE, the gNB may assign AI operation(s), e.g., an AI model to the UE.

One exemplary AI operation assignment manner is based on the base station's decision. For example, at least one of the set of AI operations, e.g., a certain AI task or AI model is assigned to the UE based on a decision of a gNB via a RRC message or an AMMP message. In some embodiments of the present application, the gNB may indicate the at least one AI operation that the gNB wants UE to support as a part of AMMP configuration, e.g., including the assigned AI operation in the first configuration information on AMMP layer.

Another exemplary AI operation assignment manner is based on UE implementation. The network side may not provide exact AI model parameters or AI task payload etc., specific AI operation information. Instead, the indication information may just indicate a requirement on the set of AI operations in a RRC message or an AMMP message, and the at least one of the set of AI operations is adopted by the UE based on implementation of the UE. The requirement on the set of AI operations may be required AI model output and required AI model performance (e.g., accuracy) etc. If the requirement, e.g., required AI model performance will be fulfilled based on the UE implementation, the UE will take or adopt a corresponding AI operation, e.g., a proper AI model of the set of AI operation.

According to some other embodiments of the present application, UE may trigger a procedure to subscribe and unsubscribe an AI operation, e.g., an AI task or an AI model. For example, the UE may inform the serving gNB that it has interest on using an AI model for channel estimation. In another example, the UE may inform the serving gNB that it has interest on contributing to a certain AI task, e.g., contributing to a federated learning and using its local data to help train an AI model. Dependent on whether AMMP layer is configured for the UE, the subscription and unsubscription procedure involve different messages in different scenarios.

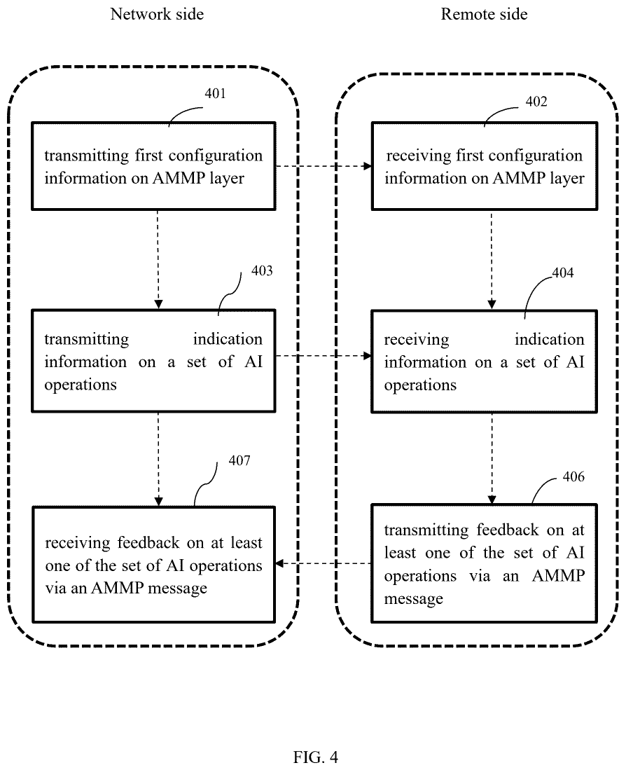

FIG. 5 is a flow chart illustrating an exemplary subscription procedure according to some embodiments of the present application. Although the method is illustrated in a system level by a network apparatus in the network side, e.g., a gNB and a remote apparatus in the remote side, e.g., a UE, persons skilled in the art can understand that the method implemented in the network side and that implemented in the remote side can be separately implemented and incorporated by other apparatus with the like functions.

As shown in FIG. 5, in step 501, the network side, e.g., a gNB transmits, a first message including indication information on a set of AI operations to the remote side, e.g., the UE. The first message informs the UE about AI operations, e.g., AI task(s) and/or AI model(s) available (or can be provided) in the network side. For the network side, in the case that AMMP layer is configured for the UE before transmitting the first message, the first message is a RRC message, or SIB, or an AMMP message. However, in the case that AMMP layer is configured for the UE after transmitting the first message, the first message is a RRC message or SIB, and cannot be an AMMP message. Consistently, for the remote side, in the case that AMMP layer is configured for the UE before receiving the first message, the first message is a RRC message, or SIB, or an AMMP message. However, in the case that AMMP layer is configured for the UE after receiving the first message, the first message is a RRC message or SIB, and cannot be an AMMP message.

The remote side, e.g., UE receives the first message including indication information on a set of AI operations in step 502. The UE may indicate its interest on subscribing or contributing at least one of the set of AI operations or its capability of subscribing or contributing at least one of the set of AI operations to the gNB. For example, the UE may inform the serving gNB, e.g., it has interest on using an AI model for channel estimation, or the UE may inform the serving gNB, e.g., it has interest on contributing to a certain AI operation, e.g., contributing to a federated learning and using its local data to help train an AI model etc. Accordingly, in step 504, the UE will transmit a second message to the gNB, which indicates that the UE is to subscribe at least part of the set of AI operations.

For the network side, in the case that AMMP layer is configured for the UE before receiving the second message (e.g., before transmitting the first message, or after transmitting the first message and before receiving the second message), the second message is a RRC message or an AMMP message. However, in the case that AMMP layer is configured for the UE after receiving the second message, the second message is a RRC message, and cannot be an AMMP message. Consistently, for the remote side, in the case that AMMP layer is configured for the UE before transmitting the second message (e.g., before receiving the first message, or after receiving the first message and before transmitting the second message), the second message is a RRC message or an AMMP message. However, in the case that AMMP layer is configured for the UE after transmitting the second message, the second message is a RRC message, and cannot be an AMMP message.

The gNB receives the second message in step 505. In step 507, the gNB transmits a third message indicating the at least one of the set of AI operations from the gNB, so that the AI operation(s) subscribed by the UE can be transmitted to the UE. Correspondingly, the UE receives the third message in step 508.

For the network side, in the case that AMMP layer is configured for the UE before transmitting the third message (e.g., before transmitting the first message, or after transmitting the first message and before receiving the second message, or after receiving the second message and before transmitting the third message), the third message is an AMMP message. However, in the case that AMMP layer is configured for the UE after transmitting the third message, the third message is a RRC message, and cannot be an AMMP message. Consistently, for the remote side, in the case that AMMP layer is configured for the UE before receiving the third message (e.g., before receiving the first message, or after receiving the first message and before transmitting the second message, or after transmitting the second message and before receiving the third message), the third message is a RRC message or an AMMP message. However, in the case that AMMP layer is configured for the UE after receiving the third message, the third message is a RRC message and cannot be an AMMP message.

Based on the above basic procedure, exemplary subscription procedures according to some embodiments of the present application are illustrated in detail as follows.

In an exemplary subscription procedure, the subscription may happen during configuring AMMP layer for UE. For example, when configuring AMMP layer for UE, the gNB also informs the UE about available AI task(s) and/or AI model(s) as a part of AMMP layer configuration (i.e., in the first configuration information) via a RRC signaling. After receiving the RRC signaling, the UE may send an AMMP layer message over the computing plane, indicating its willingness to subscribe a certain AI task and/or AI model of the informed AI task(s) and/or AI model(s). That is, the UE transmits an AMMP message to subscribe a certain AI task and/or AI model. In response to the AMMP message, the gNB may transmit the subscribed AI task and/or AI model to UE via either a RRC message or an AMMP message over the computing plane.

In addition, if the UE subscribes an AI task, the gNB may also provide configuration information related to task operation via either RRC message or AMMP message. If the UE subscribes an AI model, the gNB may also provide configuration information related to the model performance feedback operation via either RRC message or AMMP message. For example, in the case that the gNB wants the UE to train an AI model jointly, e.g., federated learning, the gNB may configure the UE to send the updated AI model parameters back to the gNB according to certain rule(s), e.g., every period or when the performance of the updated subscribed AI model outperforms that provided by the gNB by a certain threshold.

In another exemplary subscription procedure, the subscription may happen via RRC layer before configuring AMMP layer. For example, before AMMP layer is configured for UE, a gNB may inform the UE about available AI task(s) and/or AI model(s) via a RRC message or SIB signaling over the CP. After receiving the RRC signaling, the UE may send a RRC message via the CP, indicating its willingness to subscribe a certain AI task and/or AI model. That is, the UE transmits a RRC message to subscribe a certain AI task and/or AI model. In response to the RRC message from the UE, the gNB may configure AMMP layer for the UE. After AMMP layer is configured for the UE, the gNB will transmit the subscribed AI task and/or AI model to UE via an AMMP message.

In addition, if the UE subscribes an AI task, the gNB may also provide configuration information related to task operation via either a RRC message or an AMMP message. If the UE subscribes an AI model, the gNB may also provide configuration information related to the model performance feedback operation via either RRC message or AMMP message. For example, the gNB may configure the UE to evaluate and send the model performance feedback back to the gNB accordingly to certain rule(s), e.g., every period or when AI model performance degrades for a certain level, or when the AI model performance is worse than a certain threshold.

In yet another exemplary procedure, the subscription may happen via AMMP layer after AMMP lay is configured. For example, the gNB may first configure AMMP layer for the UE using a RRC message over the CP. After receiving the RRC signaling, the UE may send an AMMP layer message over the computing plane, indicating its willingness to subscribe a certain AI task and/or AI model of the informed AI task(s) and/or AI model(s). That is, the UE transmits an AMMP message to subscribe a certain AI task and/or AI model. In response to the AMMP message, the gNB may transmit the subscribed AI task and/or AI model to UE via an AMMP message over the computing plane.

In some scenarios, for the assigned or subscribed AI operation, the UE may be not willing to handle, e.g., due to overload, performance degrade or capability degrade etc. Then, the UE may trigger an unsubscription procedure to unsubscribe the assigned or subscribed AI operation. The message for unsubscription may be a RRC message or an AMMP message.

Returning to FIG. 4, after handling the at least one AI operation, e.g., an AI task and/or AI model, the UE reports the feedback on at least one AI operation to the gNB in step 406 via an AMMP message. Accordingly, the eNB receives the feedback on the at least one of the set of AI operations from the UE via the AMMP message. That is, only AMMP message will be used for transmitting feedback on assigned or subscribed AI operation by the UE.

Some embodiments of the present application also provide a message format of AMMP layer, which includes: control PDU and data PDU. The control PDU and data PDU can be sent over different LCHs and radio bearers.

An exemplary control PDU of AMMP layer (or control PDU of an AMMP message) may include information indicating at least one of the following: message type; subscribe or unsubscribe; index of AI task wanted to subscribe or unsubscribe; index of AI model wanted to subscribe or unsubscribe; and list of index of available AI operations from a base station.

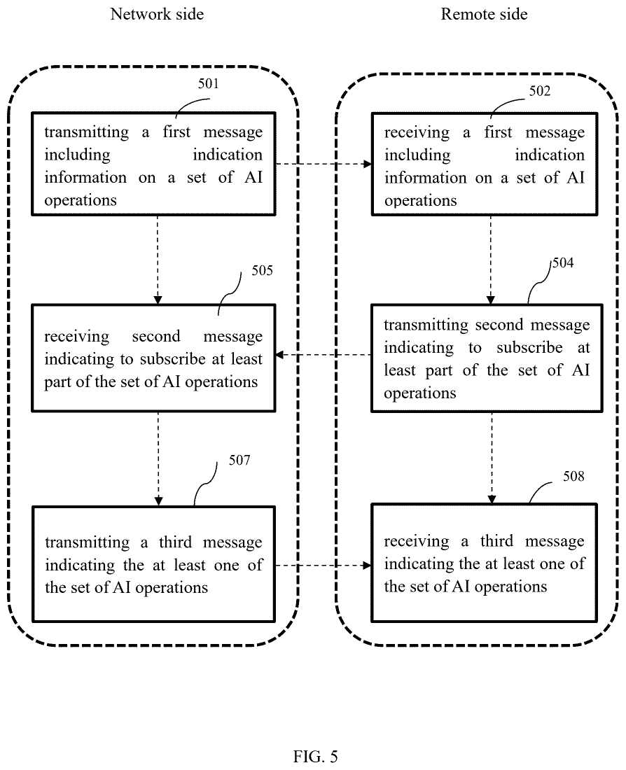

FIG. 6 illustrates an exemplary control PDU of AMMP layer according to some embodiments of the present application. As shown in FIG. 6, the exemplary control PDU of AMMP layer includes message type, i.e., the field “Type”; subscribe or unsubscribe, i.e., the field “subscribe/Unsubscribe”; and index of AI model wanted to subscribe or unsubscribe, i.e., the fields “Model Index1” and “Model Index2.”

An exemplary data PDU of AMMP layer may include information indicating at least one of the following: message type; AI task index; AI model index; input AI task index; input AI model index; output AI task index; output AI model Index; and model payload.

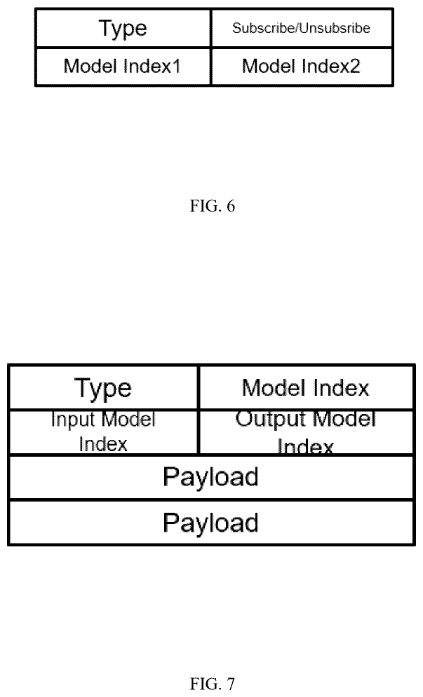

FIG. 7 illustrates an exemplary data PDU of AMMP layer according to some embodiments of the present application. As shown in FIG. 7, the exemplary data PDU of AMMP layer includes: message type, i.e., the field “Type”; AI model index, i.e., the field “Model Index”; input AI model index, i.e., the fields “Input Model Index”; output AI model Index, i.e., the field “Output Model Index”; and model payload, i.e., the fields “payload.”

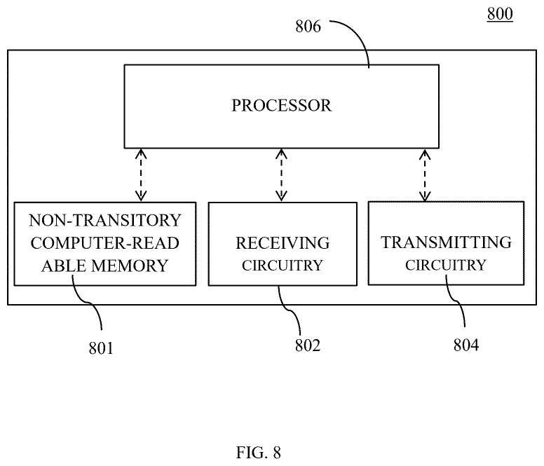

Some embodiments of the present application also provide a wireless communication apparatus of supporting AI. For example, FIG. 8 illustrates a block diagram of a wireless communication apparatus of supporting AI 800 according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The at least one processor 806 may be a CPU, a DSP, a microprocessor etc. The apparatus 800 may be a network apparatus or a UE configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

In some embodiments of the present application, the non-transitory computer-readable medium 801 may have stored thereon computer-executable instructions to cause a processor to implement the method with respect to the network apparatus, e.g., a gNB as described above. For example, the computer-executable instructions, when executed, cause the processor 806 interacting with receiving circuitry 802 and transmitting circuitry 804, so as to perform the steps with respect to a network apparatus, e.g., a gNB as depicted above.

In some embodiments of the present application, the non-transitory computer-readable medium 801 may have stored thereon computer-executable instructions to cause a processor to implement the method with respect to the UE as described above. For example, the computer-executable instructions, when executed, cause the processor 806 interacting with receiving circuitry 802 and transmitting circuitry 804, so as to perform the steps with respect to a UE as illustrated above.

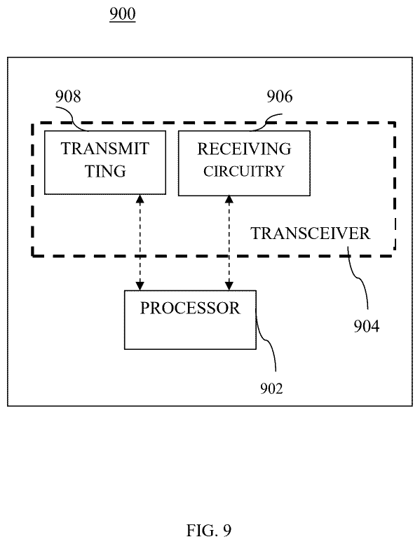

FIG. 9 is a block diagram of a wireless communication apparatus of supporting AI 900 according to some other embodiments of the present application.

Referring to FIG. 9, the apparatus 900, for example a gNB or a UE may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some embodiments of the present application, when the apparatus 900 is a network apparatus, e.g., a gNB, the processor is configured to: transmit, via the at least one transmitting circuitry, first configuration information on a protocol layer responsible for AI management in access stratum, from a network side to a UE; transmit indication information on a set of AI operations from the network side; and receive feedback on at least one of the set of AI operations from the UE, via a message on the protocol layer based on the first configuration information.

According to some other embodiments of the present application, when the apparatus 900 is a UE, the processor may be configured to: receive first configuration information on a protocol layer responsible for AI management in access stratum, from a network side; receive indication information on a set of AI operations from the network side; and transmit feedback on at least one of the set of AI operations to the network side, via a message on the protocol layer based on the first configuration information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled to the at least one memory, and configured to cause the UE to:
receive, from a network entity, first configuration information on a protocol layer responsible for artificial intelligence (AI) management in access stratum;
receive, from the network entity, indication information on a set of AI operations from the network side; and
transmit, to the network entity, feedback on at least one of the set of AI operations via a message on the protocol layer based on the first configuration information.

2. The UE of claim 1, wherein, the first configuration information indicates at least one of the following:
a list of descriptions about AI operations that a base station can provide or want the UE to support;
a list of indexes about AI operations that a base station can provide or want UE to support;
an index identifying a current entity of the protocol layer;
associated radio bearer IDs to identify an associated protocol data convergence protocol (PDCP) entity;
an indication to update an AI operations list in a base station; or
rules to provide AI model performance feedback to a base station.

3. The UE of claim 1, wherein, the at least one processor is further configured to cause the UE to:
receive third configuration information on a radio link control (RLC) entity associated with an entity of the protocol layer, wherein the RLC entity is always configured in a RLC acknowledged mode or is in a default RLC acknowledged mode.

4. The UE of claim 1, wherein, for the set of AI operations, at least one entity of the protocol layer is configured as follows:
when there is at least one AI task in the set of AI operations, a corresponding entity of the protocol layer is configured for each AI task, and when there is at least one AI model in the set of AI operations, a corresponding entity of the protocol layer is configured for each AI model; or
only one entity of the protocol layer is configured for the set of AI operations.

5. The UE of claim 1, wherein, the indication information indicates a requirement on the set of AI operations in a radio resource control (RRC) message or a message of the protocol layer, and the at least one of the set of AI operations is adopted by the UE based on implementation of the UE.

6. The UE of claim 1, wherein, the at least one processor is further configured to cause the UE to:
receive a first message including indication information on the set of AI operations;
transmit a second message indicating to subscribe at least part of the set of AI operations; and
receive a third message indicating the at least one of the set of AI operations.

7. The UE of claim 6, wherein, when that the protocol layer is configured for the UE before receiving the first message,
the first message is one of a radio resource control (RRC) message, a system information block (SIB), and a message of the protocol layer;
the second message is one of an RRC message and a message of the protocol layer; and
the third message is a message of the protocol layer.

8. The UE of claim 6, wherein, when the protocol layer is configured for the UE after receiving the first message and before transmitting the second message,
the first message is one of a radio resource control (RRC) message and system information block (SIB);
the second message is one of a RRC message and a message of the protocol layer; and
the third message is a message of the protocol layer.

9. The UE of claim 6, wherein, when the protocol layer is configured for the UE after transmitting the second message and before receiving the third message,
the first message is one of a radio resource control (RRC) message and system information block (SIB);
the second message is a RRC message; and
the third message is a message of the protocol layer.

10. The UE of claim 6, wherein, when the protocol layer is configured for the UE after receiving the third message,
the first message is one of a radio resource control (RRC) message and system information block (SIB); and
the second message and the third message are RRC messages.

11. The UE of claim 1, wherein, a control protocol data unit (PDU) of the protocol layer comprises information indicating at least one of the following:
message type;
subscribe or unsubscribe;
index of AI task wanted to subscribe or unsubscribe;
index of AI model wanted to subscribe or unsubscribe; and
list of index of available AI operations from a base station.

12. The UE of claim 1, wherein, a data protocol data unit (PDU) of the protocol layer comprises information indicating at least one of the following:
message type;
AI task index;
AI model index;
input AI task index
input AI model index;
output AI task index;
output AI model Index; and
model payload.

13. The UE of claim 1, wherein, a message format of the protocol layer comprises: control protocol data unit (PDU) and data PDU, wherein the control PDU and data PDU are sent over different logical channels (LCHs) and radio bearers.

14. A network apparatus, comprising:
at least one memory; and
at least one processor coupled to the at least one memory and and configured to cause the network apparatus to:
transmit, to a user equipment (UE), first configuration information on a protocol layer responsible for artificial intelligence (AI) management in access stratum;
transmit, to the UE, indication information on a set of AI operations; and
receive, from the UE, feedback on at least one of the set of AI operations via a message on the protocol layer based on the first configuration information.

15. A method performed by a user equipment (UE, the method comprising:
receiving, from a network entity, first configuration information on a protocol layer responsible for artificial intelligence (AI) management in access stratum;
receiving, from the network entity, indication information on a set of AI operations; and
transmitting, to the network entity, feedback on at least one of the set of AI operations via a message on the protocol layer based on the first configuration information.

16. A processor for wireless communication, comprising:
at least one controller coupled to at least one memory and configured to cause the processor to:
receive, from a network entity, first configuration information on a protocol layer responsible for artificial intelligence (AI) management in access stratum;
receive, from the network entity, indication information on a set of AI operations; and
transmit, to the network entity, feedback on at least one of the set of AI operations via a message on the protocol layer based on the first configuration information.

17. The processor of claim 16, wherein the first configuration information indicates at least one of the following:
a list of descriptions about AI operations that a base station can provide or want the processor to support;
a list of indexes about AI operations that a base station can provide or want the processor to support;
an index identifying a current entity of the protocol layer;
associated radio bearer IDs to identify an associated protocol data convergence protocol (PDCP) entity;
an indication to update an AI operations list in a base station; or
rules to provide AI model performance feedback to a base station.

18. The processor of claim 16 wherein the at least one controller is further configured to cause the processor to:
receive third configuration information on a radio link control (RLC) entity associated with an entity of the protocol layer, wherein the RLC entity is always configured in a RLC acknowledged mode or is in a default RLC acknowledged mode.

19. The processor of claim 16, wherein, for the set of AI operations, at least one entity of the protocol layer is configured as follows:
when there is at least one AI task in the set of AI operations, a corresponding entity of the protocol layer is configured for each AI task, and when there is at least one AI model in the set of AI operations, a corresponding entity of the protocol layer is configured for each AI model; or
only one entity of the protocol layer is configured for the set of AI operations.

20. The processor of claim 16, wherein the indication information indicates a requirement on the set of AI operations in a radio resource control (RRC) message or a message of the protocol layer, and the at least one of the set of AI operations is adopted by the processor based on implementation of the processor.
